(19) United States
(12) Patent Application Publication
(10) Pub. No.: US 2007/0108165 A1
(43) Pub. Date: May 17, 2007

(54) Configurations and methods for improved plasma torch

(76) Inventors: Viktor I. Petrik, (US); Alexander Bobarykin, (US)

Correspondence Address: Robert D. Fish;Rutan & Tucker, LLP, 611 ANTON BLVD, SUITE 1400, COSTA MESA, CA, 92626, US

(21) Appl. No.: 11/282,457

(22) Filed: Nov. 17, 2005

(51) Int. Cl. B23K 9/00

(52) U.S. Cl. 219/121.5

(57) ABSTRACT

Water plasma is generated from steam, wherein one portion of the steam serves as plasma fuel and wherein another portion of the stream stabilizes the plasma jet in a vortex that is formed in a vortex generator. Most preferably, the vortex momentum is generated at least in part outside the plasma generation chamber and then transferred into the chamber at two locations with two distinct vortex velocities. Contemplated configurations allow significantly extended operation times at remarkably reduced power consumption and produce a stabilized high-temperature plasma jet suitable for welding and/or cutting.

### FIELD OF THE INVENTION

The field of the invention is in situ generation/combustion of electrolytically hydrolyzed water and water plasma.

### BACKGROUND OF THE INVENTION

High-temperature combustion of gases for welding and cutting is well known in the art, and the choice of selected gases for combustion is typically determined by the desired flame temperature. For example, combustion of various hydrocarbons (e.g., methane, ethane, propane) with air or oxygen will typically yield flame temperatures of between about 1900 to 2000° C. Where higher flame temperatures are desired, acetylene is combusted with oxygen with a flame temperature commonly between about 2500° C. to 3000° C. Alternatively, and depending on the particular molar ratio, hydrogen and oxygen can be combusted to produce flame temperatures between about 2200° C. to 5500° C.

In most known welding/cutting applications, the combustion gas (or gases) is provided by a storage vessel (e.g. pressurized acteylene and/or oxygen gas cylinder), which is then combined in the welding/cutting torch with atmospheric oxygen or a dedicated oxygen stream. In other, less common applications, one gas is generated in a gas generator (e.g., acetylene via hydrolysis of calcium carbide), and then combined with air or oxygen supplied from storage vessel. In still other examples, both gases (typically oxygen and hydrogen) components are separately generated by a gas generator and delivered to the welding torch in separate lines (e.g., water hydrolysis in electrolyzer to separately generate hydrogen and oxygen). In yet another, relatively poorly characterized device, Brown's gas (2H₂:O₂) is generated in an electrolytic cell and supplied to the torch. Therefore, and regardless of the particular manner of gas delivery to the torch, numerous disadvantages remain. Among other problems, supply lines, gas generators, and/or gas cylinders reduce portability of the welding/cutting equipment. Moreover, in case of a leak in the supply chain to the torch, serious injury may occur due to spontaneous explosion, or the device may be rendered inoperable.

Alternatively, plasma torches may be used for metals that are difficult to cut using a high-temperature flame, in which an electrically conductive gas (e.g., argon, hydrogen, nitrogen, plus air and oxygen) transfers energy from an electrical power source through the plasma cutting torch to the material being cut. While plasma torches can achieve relatively high temperatures (e.g., well above 3000° C.), various new problems arise. Most significantly, currently known plasma torches require substantial quantities of energy, and power requirements upwards of 20,000 W are not unusual. Still further, plasma torches are frequently relatively complex devices, which often need cooling, jet stabilizing, and other components to allow for controlled operation. Thus, the size of currently known plasma torches and associated equipment typically precludes hand-held operation (see e.g., GB 1 377 987, U.S. Pat. No. 3,459,376, U.S. Pat. No. 3,825,718, U.S. Pat. No. 5,362,939, U.S. Pat. No. 5,372,857, U.S. Pat. No. 5,451,740, U.S. Pat. No. 5,808,267, U.S. Pat. No. 6,114,649, or U.S. Pat. No. 5,637,242).

To overcome at least some of the problems with portability, relatively small devices were described (see e.g., WO 94/19139, U.S. Pat. No. 5,609,777, U.S. Pat. No. 6,087,616, and U.S. Pat. No. 6,156,994), which can be employed to cut and weld various metals. While such devices can be used in hand-held operation, numerous difficulties precluded such devices from successful commercial exploitation. Among other things, power consumption is still relatively high at up to about 1,000 W, and even higher. Still further, such devices typically operate only for a relatively short period and often tend to fail in less than 20 minutes. Moreover, the plasma jet produced in such devices is often not sufficiently stable to allow for reliable cutting of relatively thick and/or heat resistant materials.

Therefore, while numerous devices and methods for cutting and welding of metals are known in the art, all or almost all of them suffer from one or more disadvantages. Consequently, there is still a need to provide improved cutting and welding devices, and especially portable and self-contained devices.

### SUMMARY OF THE INVENTION

The present invention is directed to devices and methods in which water plasma is formed using one or more vortex generators that deliver water steam for plasma generation as well as for stabilization of the plasma jet via a water steam vortex. Most remarkably, such devices can be configured to a hand-held format while having substantially reduced power requirements and a significantly improved operation time and jet stability. In one preferred aspect, such devices are hand-held and battery operated, and require as only consumable tap water for a sustained operation of up to one hour, and even longer.

In a further preferred aspect of the inventive subject matter, a plasma torch includes a primary vortex generator with a first portion that is configured to vaporize a water containing liquid to thereby form a vapor, and a second portion that is configured to receive a first portion of the vapor and to impart a first tangential motion of the vapor in a plasma generation chamber. A secondary vortex generator is coupled to the primary vortex generator and configured to receive a second portion of the vapor from the primary vortex generator and to impart a second tangential motion of the vapor in the plasma generation chamber, wherein the plasma generation chamber is formed at least in part by the (preferably cylindrical inner walls of) primary and secondary vortex generators and an anodic cap.

In such devices it is especially preferred that the second portion of the primary vortex generator has a plurality of tangential openings that fluidly connect the plasma generation chamber with an outer surface of the primary vortex generator, and/or that the outer surface of the primary vortex generator has a helical groove on the outer surface, wherein the groove is configured to impart helical movement of the first portion of the vapor to the to the plurality of tangential openings. It is further preferred that the secondary vortex generator has a plurality of tangential openings that fluidly connect the plasma generation chamber with an outer surface of the secondary vortex generator, wherein (most preferably) the outer surface of the secondary vortex generator has a helical groove on the outer surface that is configured to impart helical movement of the second portion of the vapor to the to the plurality of tangential openings. A cathode (preferably comprising zirconium nitride or hafnium nitride) is preferably coupled to a cathode holder and configured such that the cathode extends into the plasma generation chamber and the cathode holder extends through the first portion of the primary vortex generator. Most typically the first portion of the primary vortex generator is configured such that the liquid is vaporized on an outer surface or within an insulating porous ceramic element on or near an inner surface of the first portion. Typically (but not necessarily), the second tangential motion is faster than the first tangential motion. A secondary battery or super-capacitor that supplies current to the anodic cap and the cathode may be included where the plasma torch is configured as a hand-held device.

In another preferred aspect of the inventive subject matter, the plasma torch comprises an anode arrangement in which a housing circumferentially encloses a cylindrical vortex generator having an outer cylinder surface and an inner cylinder surface, wherein the inner surface forms part of a plasma generation chamber, and wherein the outer surface and an inner surface of the housing define a space configured to allow passage of a vapor of a water-containing fluid. In such devices, it is typically preferred that the vortex generator has a plurality of tangential openings that fluidly connect the outer surface of the vortex generator with the inner surface of the vortex generator, wherein the openings are configured such that the vapor enters the openings and the plasma generation chamber in a tangential motion.

Most preferably, such devices have a helical groove on the outer surface of the vortex generator that imparts helical motion of the vapor on the outer surface. It is further preferred that the groove terminates upstream of the openings at a distance effective to enable passage of the vapor through the openings while the vapor is in helical motion. Moreover, a second vortex generator may be included that is configured to form another part of the plasma generation chamber.

Therefore, a method of manufacturing a plasma torch will include a step in which a source of water-containing vapor is provided. In another step, a cylindrical anode space is formed having at least one deflector that is configured such that when a portion of the vapor is introduced into the cylindrical anode space, a helical motion is imparted to the vapor within the space. In yet another step, an opening is provided in the anode space and configured such that the vapor is transferred from the cylindrical anode space into a plasma generation chamber in a tangential manner. Where desirable, a second deflector may be included in the cylindrical anode space and a second opening, wherein the second deflector is configured to impart a second helical motion to another portion of the vapor, and wherein the second opening is configured such that the vapor is transferred from the cylindrical anode space into the plasma generation chamber. Preferably, the second helical motion is faster than the first helical motion in such methods.

Various objects, features, aspects and advantages of the present invention will become more apparent from the drawings and following detailed description of preferred embodiments of the invention.

### BRIEF DESCRIPTION OF THE DRAWING

FIG. 1 is a photograph of an exemplary primary vortex generator.

FIG. 2 is a photograph of an exemplary secondary vortex generator.

FIG. 3 is a photograph of an exemplary cathode assembly.

FIG. 4A is a photograph depicting a detail view of the primary vortex generator with inserted cathode assembly, the secondary vortex generator, and the anodic cap in disassembled configuration.

FIG. 4B is a photograph depicting a detail view of the primary vortex generator with inserted cathode assembly, the secondary vortex generator, and the anodic cap in an assembled configuration.

FIG. 4C is a photograph depicting a detail view of the primary vortex generator with inserted cathode assembly, the secondary vortex generator, the anodic cap, and the anode housing in disassembled configuration.

FIG. 4D is a photograph depicting a detail view of the assembled vortex generator of FIG. 4B in which the assembly is inserted into the anode housing.

FIG. 5 is a photograph depicting an exemplary hand-held plasma torch in operation cutting a stainless steel bar at a power consumption of about 150 W using water as plasma fuel.

### DETAILED DESCRIPTION

The inventors discovered that a high-temperature plasma torch can be constructed in a surprisingly simple configuration in which water vapor serves as fuel and as a stabilizing agent for a plasma jet formed in such devices. Remarkably, contemplated devices can be operated at a power consumption of about 150 W (e.g., delivered by a battery) while producing a plasma jet suitable for effective cutting of stainless steel and other refractory metals, wherein continuous operation is typically longer than 30 minutes, and even more typically up to one hour (and longer). Still further, contemplated devices need no moving parts during operation and require only water or a water-containing fluid for operation.

While not wishing to be bound by any theory or hypothesis, the inventors contemplate that at least some of the favorable operational parameters are due to the vortex generators used in such devices. In preferred embodiments, the vortex is formed by a vapor (typically water vapor) in at least one, and more typically two vortex generators that feed the vapor into the plasma generation chamber at a tangential momentum. Where more than one vortex generator is employed, it is typically preferred that the upstream (relative to the opening through which the plasma jet is released) vortex generator produces a tangential motion that is slower than that produced by a downstream vortex generator. Thus, the vortex in contemplated devices provides for increased focus and stability of the plasma jet.

In one preferred exemplary device, a plasma torch includes a primary vortex generator that has a first portion configured to vaporize a water containing liquid to thereby form vapor, and further has a second portion configured to receive at least part of the vapor and to impart a first tangential motion to the vapor in a plasma generation chamber. A secondary vortex generator is then coupled to the primary vortex generator and configured to receive another part of the vapor from the primary vortex generator and to impart a second tangential motion of the vapor in the plasma generation chamber, wherein the plasma generation chamber is formed at least in part by the (typically inner cylindrical walls of the) primary and secondary vortex generators and an anodic cap. Most preferably, the second tangential motion is faster than the first tangential motion.

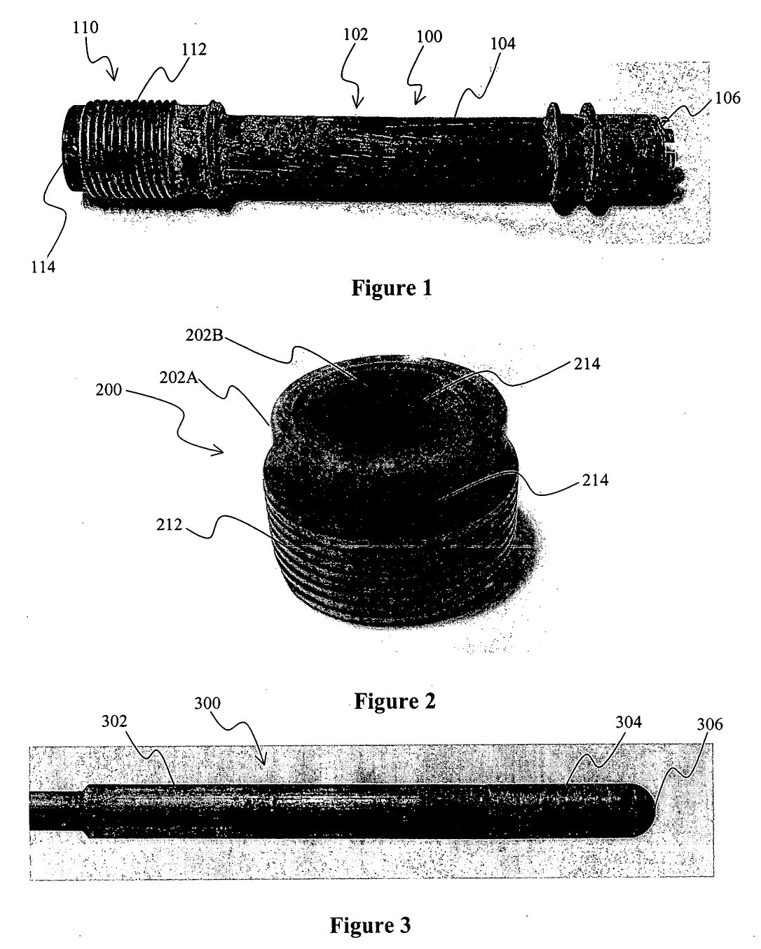

FIG. 1 depicts an exemplary primary vortex generator 100 in which the first portion 102 is formed from rod 104 and rear opening 106. In preferred embodiments, rod 104 is covered by porous and thermally insulating material (e.g. foamed glass, mineral wool, etc.) to the level of the height of the flanges. Opening 106 is typically configured to accommodate the cathode assembly, which is electrically separated from the rod 104, preferably via ceramic rings (not shown). Water in contact with or proximal to the rod will vaporize by virtue of inductive heat generated by electric current between the rod and the cathode (via arc and anodic cap). Coupled to the rod 104 (most typically: integral with the rod 104) is the second portion 110. On the outer surface of the second portion is thread 112 and a recessed portion in which a plurality of openings 114 are located. Thus, vapor moving from the first to the second portion (see below) will be guided through the thread into a helical motion. The openings 114 are preferably cut at an angle that is other than a radius, and most typically the angle will be about 30 degrees off the radius. By use of such angled opening, the circular motion of the vapor is maintained or even boosted as the vapor travels from the outer surface of the second portion into the inner space formed by the inner cylindrical wall of the second portion.

Therefore, it should be appreciated that the first portion of the primary vortex generator is configured such that the liquid is vaporized on an outer surface of the first portion. Alternatively, the first portion of the primary vortex generator may also be configured such that at least part of the liquid is vaporized on or near an inner surface of the first portion. In such configurations, it is particularly preferred that a porous ceramic element is coupled to the inner surface, wherein at least part of the liquid is vaporized in the ceramic element. In still further contemplated aspects, it is contemplated that the vapor may also be generated in a device separate from the primary vortex generator, and all vapor generating devices are deemed suitable for use herein. For example, vapor may be delivered as a hot steam from a dedicated boiler or other steam generator. On the other hand, the vapor may also be provided by an ultrasound transducer or mister. Therefore, it should be recognized that the first portion may be configured in numerous manners, and that the first portion may be contiguous, or separate from the second portion so long as the first portion delivers vapor to the second portion. Delivery of the vapor may consequently be performed by collocating the first and second portions, and/or by providing distinct delivery channels or delivery conduits to the second portion, wherein the channels and/or conduits may or may not provide helical momentum to the vapor.

Most typically, the second portion of the primary vortex generator is continuous with the first portion to thereby receive the vapor from the first portion and further has a plurality of tangential openings that fluidly connect the plasma generation chamber with the outer surface of the second portion of the primary vortex generator. In further preferred aspects, the outer surface of the primary vortex generator has a helical groove (or other deflector, which may or may not be adjustable in angle) on the outer surface, wherein the groove/deflector is configured to allow helical movement of the first portion of the vapor to the to the plurality of tangential openings. Thus, it should be recognized that the vapor is first put into a helical movement and then introduced into the plasma generation chamber at a tangential angle to maintain or even further strengthen the helical momentum. As the second portion of the primary vortex generator is heated by the plasma generation inside the plasma generation chamber, it should be noted that re-condensation of the vapor to a liquid phase is completely prevented. Consequently, the plasma arc will be stabilized by a vapor vortex, and plasma fuel and the plasma jet will be further stabilized by a rotating momentum.

Depending on the particular size and other considerations, it should be recognized that the number of openings may vary considerably. However, it is typically preferred that the number of openings is between about one and ten, and most typically between three and five. Furthermore, the openings are typically channels that are cut or otherwise positioned such that vapor passing through the openings will enter the plasma generation chamber at a tangential momentum. Thus, typical angles will be between about 10-50 degrees (calculated from a radius), and most preferably at about 25-45 degrees, wherein the angle will correspond with the helical direction of the thread or other deflector. Suitable other deflectors includes fins, channels, spiral guides, etc. Moreover, and especially where a secondary vortex generator is employed, it should be noted that the openings are configured such that not all of the vapor will enter through the openings in the first vortex generator, but that at least 10%, more typically at least 20%, and most typically at least 30% of the vapor moved further to the secondary vortex generator. Still further, it is preferred (but not necessary) that the openings are typically located in a recessed portion of the second portion in the primary vortex generator.

The recessed portion of the second portion of the primary vortex generator engages then with a secondary vortex generator, preferably in an end-to-end manner. An exemplary secondary vortex generator 200 is depicted in FIG. 2. Here, the ring shaped vortex generator 200 has an open bottom portion that engages with the front end of the primary vortex generator, and an open top portion that engages with the anodic cap (see below). Similar to the primary vortex generator, the secondary vortex generator has an outer cylindrical surface 202A with a thread along which vapor is guided into a helical motion having the same helicity (e.g., clockwise) as the thread 112 in the primary vortex generator. Thread 212, however, has preferably a higher thread count per inch than thread 112 to thereby increase helical motion of the vapor in thread 212 relative to the helical motion of the vapor in thread 112. Similar to the primary vortex generator, the secondary vortex generator has a recessed area with a plurality of openings 214 that are preferably cut at an angle to allow the helically moving vapor to enter the inner space (defined by the inner surfaces 202B) of the secondary vortex generator with tangential momentum.

Thus, in especially preferred aspects, the secondary vortex generator has a plurality of tangential openings that fluidly connect the plasma generation chamber with the outer surface of the secondary vortex generator, which most typically has a helical groove on the outer surface. The groove or other deflector is generally configured to induce or allow helical movement of the vapor to the to the plurality of tangential openings. With respect to alternative configurations, the same considerations as applied to the second portion of the primary vortex generator apply. Thus, it should be appreciated that primary and secondary vortex generators cooperate to produce vapor and to introduce the vapor at a tangential momentum into the plasma generation chamber.

With respect to the vapor, it should be appreciated that numerous fluids may be employed in conjunction with the teachings presented herein. However, most preferably, the fluid includes water, which is easily transfer to the vapor phase by steam generation. Alternatively, or additionally, the water may be admixed or even replaced with one or more non-aqueous solutions, and suitable solutions include hydrocarbon fuel, organic solvents (e.g., methanol, ethanol, etc.), acids, bases, which may or may not include salts (e.g., metal salts, mineral salts, etc.). Addition of solvents may advantageously reduce the boiling point or other physicochemical characteristics (e.g., reduced tendency to oxidize). Moreover, the vapor may further be spiked or replaced with combustible gases, and especially with methane, ethane, ethylene, acetylene, etc.

Exemplary FIG. 3 depicts a cathode assembly 300 in which a rod-shaped cathode holder 302 is conductively coupled to heat conducting cathode body 304, which includes an insert of refractory material 306 with favorable electron emission characteristics (e.g., zirconia, zirconium nitride, or hafnium nitride). In most of contemplated devices, the cathode assembly is configured to fit within the central opening of the primary vortex generator and is maintained in electrical isolation from the primary vortex generator via an insulating spacer. Therefore, it is generally preferred that a cathode is coupled to a cathode holder such that the cathode extends into the plasma generation chamber, wherein the cathode holder extends at least partially through the first portion of the primary vortex generator. Where desirable, the first portion of the primary vortex generator that encloses the cathode holder is hermetically sealed from the plasma generation chamber. Alternatively, it is also contemplated that the first portion may be open to thereby provide a portion of the vapor to the plasma generation chamber.

Thus, and viewed from a different perspective, contemplated plasma torches will include an anode arrangement in which a housing circumferentially encloses a cylindrical vortex generator having an outer cylinder surface and an inner cylinder surface, wherein the inner surface forms part of a plasma generation chamber, and wherein the outer surface of the anode arrangement and an inner surface of the housing define a space configured to allow passage of a vapor of a water-containing fluid. The vortex generator preferably has a plurality of tangential openings that fluidly connect the outer surface of the vortex generator with the inner surface of the vortex generator (the plasma generation chamber), wherein the openings are configured such that the vapor enters the openings and the plasma generation chamber in a tangential motion.

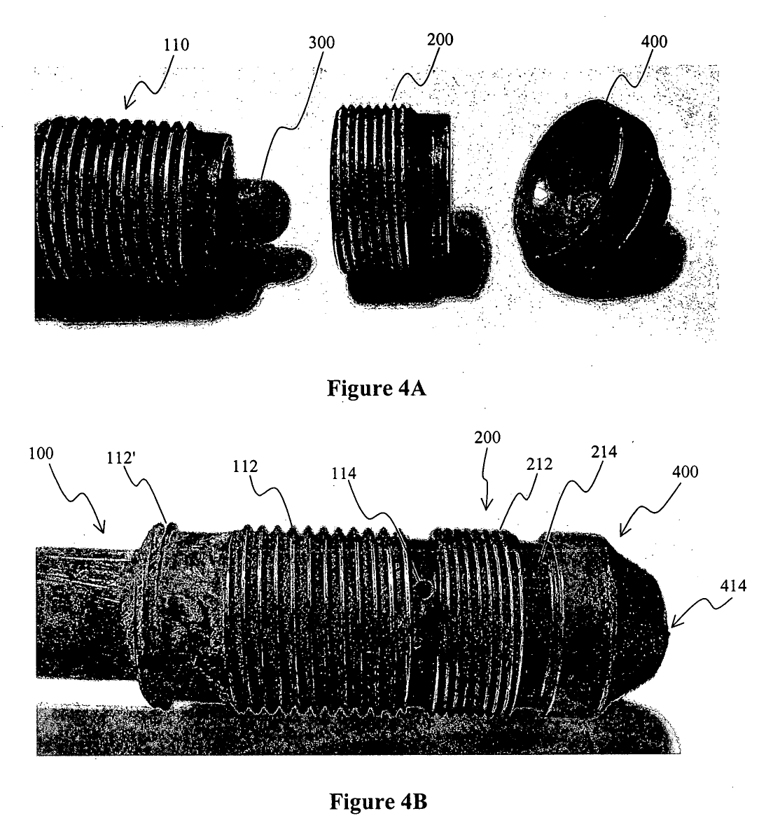

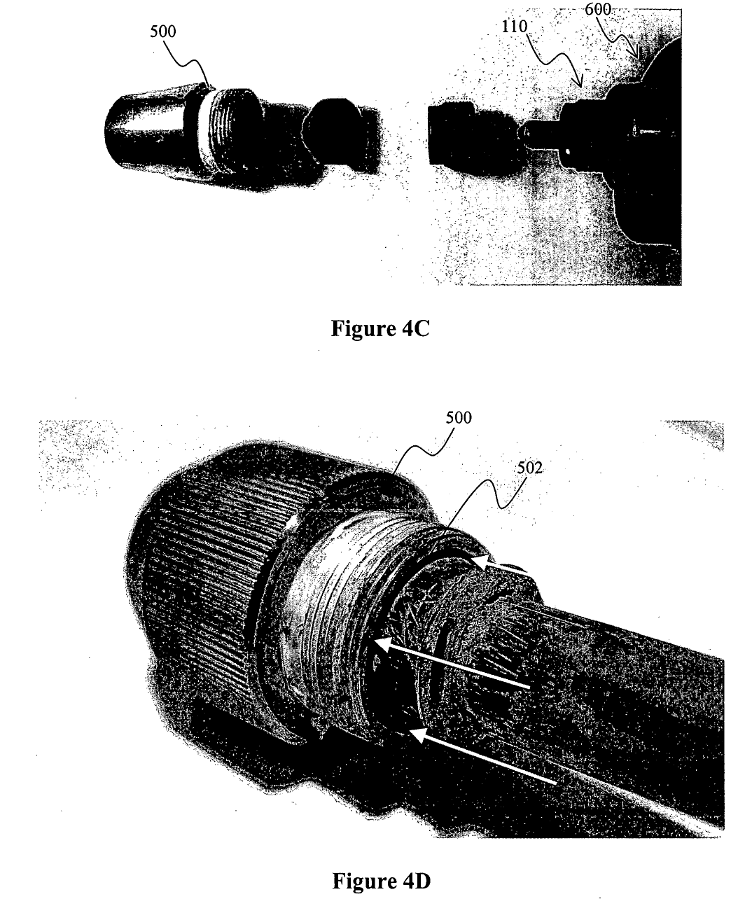

For example, FIG. 4A depicts a partial assembly of the primary vortex generator with the first portion 110 shown, which partially encloses the cathode assembly 300 such that the cathode body protrudes into a cavity (the plasma generation chamber) defined by the inner surfaces of the primary vortex generator 110, the secondary vortex generator 200, and the anodic cap 400. Where desired, the first portion of the primary vortex generator may be fluidly isolated from the plasma generation chamber, or may be fluidly coupled to the plasma generation chamber (e.g., where the vapor is generated within the space defined by the inner surface of the first portion of the primary vortex generator). FIG. 4B depicts the assembled plasma generation chamber in which the first portion of primary vortex generator 100 has an upstream deflector 112′ that is followed by a second deflector (thread 112). The recessed portion of the primary vortex generator includes a plurality of openings 114 that receive at least part of the vapor coming from upstream deflector. Remaining vapor will travel further towards secondary vortex generator 200 having a third deflector (thread 212), wherein the third deflector is at an angle sufficient to impart further helical momentum to the vapor that will then enter the plasma generation chamber via openings 214. The plasma generation chamber is the completed by anodic cap 400 having opening 414 though which the plasma jet emanates. Cathode (not shown, see FIG. 3) will provide an arc to the anodic cap (and/or the primary or secondary vortex generator). Electric connection to the cathode is preferably via the cathode holder, while the electric connection for the anode is preferably through contact with the anode housing as depicted in exemplary FIG. 4C. Here, the anode housing 500 connects with a corresponding anode ring 600 in the insulated portion of a hand-held plasma torch. Protruding from the anode ring is the second portion 110 of the primary vortex generator.

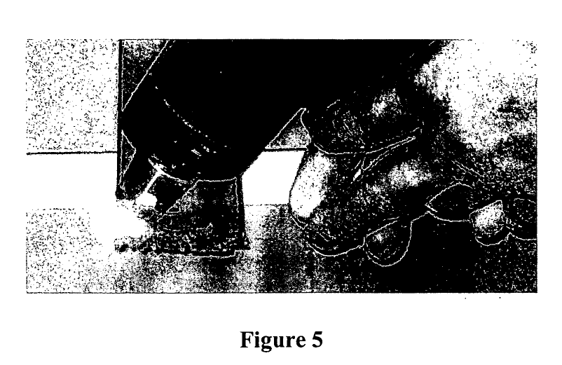

FIG. 4D depicts in more detail the assembly of the plasma generation chamber, which is inserted into the anode housing 500 such that a small cylindrical space 502 is generated between the outside surfaces of the plasma generation chamber and the inside surface of the anode housing. Access of vapor to the inside of the plasma generation chamber is schematically illustrated by the arrows in FIG. 4D. Therefore, it should be recognized that one or more deflectors in contemplated devices (typically one or more helical grooves on the outer surface of the vortex generators) will impart helical motion of the vapor disposed between the outer surface of the vortex generators and the inner surface of the anode housing. Most typically, the groove terminates upstream of the openings at a distance effective to enable passage of the vapor through the openings while the vapor is in helical motion. As shown in the Figures, it is generally preferred that at least a second vortex generator is configured to form another part of the plasma generation chamber. The outside thread of the anode housing 500 preferably and sealingly engages with the anode ring (which may be part of a fluid reservoir). Thus, it is further contemplated that preferred devices include a reservoir for the liquid that is fluidly coupled to the primary vortex generator. Most preferably, such devices will include a secondary battery or super-capacitor that supplies a current to the anodic cap and the cathode suitable for generation of an arc, wherein the plasma torch is configured as a hand-held device. Operation of an exemplary hand-held device is depicted in FIG. 5 in which a stainless steel bar of ⅛ inch thickness was cut within several seconds using only water vapor as the plasma fuel and stabilizer, and using about 150 W of electrical energy. Other uses contemplated herein include use as welding and cutting tool for metals, metal alloys, glass, concrete, etc., but also use in thermal and/or plasma destruction of toxic or otherwise undesirable materials. Especially contemplated uses include those in which the device is configured as a hand-held device and in which at least part of the power required is provided by a (secondary) battery or super capacitor. Furthermore, and especially where the device is self-contained and at least partially sealed, contemplated devices may also employed in submerged environment.

Additionally, and where desired, it is contemplated that the plasma jet may further be stabilized or focused using a magnetic field. For example, suitable magnetic fields may be generated with a permanent magnet (e.g., ring magnet that is part of, or adjacent to the plasma generation chamber), or an electromagnet (which may or may not be configured to produce a variable magnetic field). Most typically, the north-south axis of the magnet will be parallel to the direction of the plasma jet, however, alternative configurations are also deemed suitable herein.

Consequently, a method of manufacturing a plasma torch will include a step in which a source of water-containing vapor is provided (e.g., tank, sponge, hot/cold steam generator etc.). In another step, an (preferably cylindrical) anode space is formed having at least one deflector such that when a portion of the vapor is introduced into the cylindrical anode space, a helical motion is imparted to the vapor within the space. In yet another step, an opening is formed or provided in the anode space and configuring such that the vapor is transferred from the cylindrical anode space into a plasma generation chamber in a tangential manner.

Most typically, a second deflector and a second opening are formed in the cylindrical anode space, wherein the second deflector is configured to impart a second helical motion to another portion of the vapor, and wherein the second opening is configured such that the vapor is transferred from the cylindrical anode space into the plasma generation chamber. Therefore, under most circumstances, it is preferred that the second helical motion is faster than the first helical motion.

Thus, specific embodiments and applications of devices and methods for improved plasma torches have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Furthermore, where a definition or use of a term in a reference, which is incorporated by reference herein is inconsistent or contrary to the definition of that term provided herein, the definition of that term provided herein applies and the definition of that term in the reference does not apply.

1. A plasma torch comprising:
a primary vortex generator having a first portion that is configured to vaporize a water containing liquid to thereby form a vapor, and further having a second portion that is configured to receive a first portion of the vapor and to impart a first tangential motion of the vapor in a plasma generation chamber;
a secondary vortex generator coupled to the primary vortex generator and configured to receive a second portion of the vapor from the primary vortex generator and to impart a second tangential motion of the vapor in the plasma generation chamber;
wherein the plasma generation chamber is formed at least in part by the primary and secondary vortex generators and an anodic cap.

2. The plasma torch of claim 1 wherein the second portion of the primary vortex generator has a plurality of tangential openings that fluidly connect the plasma generation chamber with an outer surface of the primary vortex generator.

3. The plasma torch of claim 2 wherein the outer surface of the primary vortex generator has a helical groove on the outer surface, wherein the groove is configured to allow helical movement of the first portion of the vapor to the to the plurality of tangential openings.

4. The plasma torch of claim 1 wherein the secondary vortex generator has a plurality of tangential openings that fluidly connect the plasma generation chamber with an outer surface of the secondary vortex generator.

5. The plasma torch of claim 4 wherein the outer surface of the secondary vortex generator has a helical groove on the outer surface, wherein the groove is configured to allow helical movement of the second portion of the vapor to the to the plurality of tangential openings.

6. The plasma torch of claim 1 further comprising a cathode coupled to a cathode holder and configured such that the cathode extends into the plasma generation chamber and the cathode holder extends through the first portion of the primary vortex generator.

7. The plasma torch of claim 6 wherein the first portion of the primary vortex generator is configured such that the liquid is vaporized on an outer surface of the first portion.

8. The plasma torch of claim 6 wherein the cathode comprises zirconium nitride or hafnium nitride.

9. The plasma torch of claim 1 wherein the first portion of the primary vortex generator is configured such that at least part of the liquid is vaporized on or near an inner surface of the first portion.

10. The plasma torch of claim 9 further comprising a porous ceramic element coupled to the inner surface, and wherein the at least part of the liquid is vaporized in the ceramic element.

11. The plasma torch of claim 1 wherein the second tangential motion is faster than the first tangential motion.

12. The plasma torch of claim 1 further comprising a reservoir for the liquid that is fluidly coupled to the primary vortex generator.

13. The plasma torch of claim 1 further comprising a secondary battery or super-capacitor that supplies a current to the anodic cap and a cathode, wherein the plasma torch is configured as a hand-held device.

14. A plasma torch comprising:
an anode arrangement in which a housing circumferentially encloses a cylindrical vortex generator having an outer cylinder surface and an inner cylinder surface;
wherein the inner surface forms part of a plasma generation chamber, and wherein the outer surface and an inner surface of the housing define a space configured to allow passage of a vapor of a water-containing fluid; and
wherein the vortex generator has a plurality of tangential openings that fluidly connect the outer surface of the vortex generator with the inner surface of the vortex generator, and wherein the openings are configured such that the vapor enters the openings and the plasma generation chamber in a tangential motion.

15. The plasma torch of claim 14 further comprising a helical groove on the outer surface of the vortex generator, wherein the groove imparts helical motion of the vapor on the outer surface.

16. The plasma torch of claim 15 wherein the groove terminates upstream of the openings at a distance effective to enable passage of the vapor through the openings while the vapor is in helical motion.

17. The plasma torch of claim 14 further comprising a second vortex generator configured to form another part of the plasma generation chamber.

18. A method of manufacturing a plasma torch, comprising:
providing a source of water-containing vapor;
forming a cylindrical anode space having at least one deflector such that when a portion of the vapor is introduced into the cylindrical anode space, a helical motion is imparted to the vapor within the space; and
providing an opening in the anode space and configuring the opening such that the vapor is transferred from the cylindrical anode space into a plasma generation chamber in a tangential manner.

19. The method of claim 18 further comprising a step of forming in the cylindrical anode space a second deflector and a second opening, wherein the second deflector is configured to impart a second helical motion to another portion of the vapor, and wherein the second opening is configured such that the vapor is transferred from the cylindrical anode space into the plasma generation chamber.

20. The method of claim 19 wherein the second helical motion is faster than the first helical motion.
